(19) United States
(12) Patent Application Publication
(10) Pub. No.: US 2023/0034089 A1
(43) Pub. Date: Feb. 2, 2023

(54) SYSTEM FOR DETECTING AND VISUALIZING DEMOGRAPHICS, DIVERSITY AND DISPARITY IN USER-GENERATED VIDEOS

(71) Applicant: Vyrill Inc., San Francisco, CA (US)

(72) Inventors: Koninika Patel, Sunnyvale, CA (US); Barbara Rosario, Berkeley, CA (US); Daina Reed, Santa Cruz, CA (US)

(21) Appl. No.: 17/877,685

(22) Filed: Jul. 29, 2022

Related U.S. Application Data
(60) Provisional application No. 63/227,321, filed on Jul. 29, 2021.

(51) Int. Cl. G06V 20/40; G06F 3/0481; G06Q 30/02

(52) U.S. Cl. CPC G06V 20/41; G06F 3/0481; G06Q 30/0201; G06V 20/48

(57) ABSTRACT

A system for detecting and visualizing demographics, diversity and disparity in user-generated videos includes a collection of user-generated content, such as videos, having demographic information, a target collection of content having defined diversity information, creator content having diversity information, and a processor capable of performing a diversity analysis on the user-generated content, displaying an indication of disparity between the user-generated content and the target collection of content, and taking an action based on the analysis to modify the collection to more closely reflect the target collection of information such as inviting content creators to contribute to the collection content associated with the identified areas of disparity.

### BACKGROUND

### Field of the Invention

This invention relates to computer systems for analyzing media content using Artificial Intelligence (Al) or machine learning, and more particularly, to a system for detecting and visualizing demographics, diversity, and disparity in user-generated videos.

### Discussion of the Prior Art

User-generated content (UGC), alternatively known as user-created content (UCC), is any form of content, such as images, videos, text and audio, that have been posted by users on online platforms such as social media.

For consumers, UGC, particularly user-generated videos (UGVs), have become an increasingly common source of information on brands and their related products and services. UGVs can include reviews, tutorials and demonstrations that directly educate consumers about products or services, or they can indirectly expose consumers to brands through product placement, wherein products or services are incorporated into content such as home videos or web series. On YouTube, the largest online video platform, over 500 hours of videos are uploaded every minute, with over 5 billion videos watched every day, many of which are UGVs featuring brands, products or services.

There is a growing need for companies to better understand and control the influence UGVs have on consumer perception of their brands. Companies are particularly interested in monitoring demographics (e.g., race, gender and age) of individuals appearing in UGVs alongside their brands and in finding ways to improve upon the diversity of those demographics.

While prior art methods exist for quantifying diversity, these methods fall short of providing meaningful and actionable insights to brand managers or content creators. In addition, there is a need for a scalable system that can score and visualize diversity among large and ever-growing catalogs of UGVs hosted on platforms such as YouTube.

### SUMMARY OF THE INVENTION

The present invention provides a system for detecting and visualizing demographics, diversity and disparity in UGVs.

The system is configured to generate diversity and disparity scores for UGVs, where diversity is a measure of the inclusion of different types of people (e.g., race, gender and age) in a video or collection of videos and disparity is a measure that compares the types of people in one video or collection of videos to those in another video or collection of videos. The system visualizes diversity and disparity scores, along with other demographic information, in meaningful and actionable ways, and it can be used by both brand managers and content creators to analyze and take strategic action based on the diversity and disparity scores.

### BRIEF DESCRIPTION OF THE DRAWINGS

Exemplary embodiments of the invention will now be described with reference to the accompanying drawings, in which:

FIG. 1 shows a user interface or dashboard of a system according to the invention, the dashboard providing a home page for a brand manager to access the system’s functionality.

FIG. 2 shows another view of a user interface or dashboard of a system according to the invention, wherein all videos of a single product are being compared to all videos of a product category.

FIG. 3 shows another view of a user interface or dashboard of a system according to the invention, wherein diversity and demographic information are shown for all videos of a single product.

FIG. 4 shows another view of a user interface or dashboard of a system according to the invention, wherein diversity, disparity and demographic information are shown for a single video.

FIG. 5 shows another view of a user interface or dashboard of a system according to the invention, wherein diversity, disparity and demographic information are shown for a single content creator.

FIG. 6 shows a user interface component that enables the user to take actions based on diversity and demographic information.

FIG. 7 shows a user interface component that enables the user to take control the weighted averaging of a cumulative diversity score.

FIG. 8 shows another view of a user interface or dashboard of a system according to the invention, wherein a content creator can license a video to a company or brand manager.

FIG. 9 shows another view of a user interface or dashboard of a system according to the invention, wherein a brand manager can create a brand management campaign.

FIG. 10 shows another view of a user interface or dashboard of a system according to the invention, wherein a content creator can connect with ongoing brand management campaigns.

### DETAILED DESCRIPTION OF THE ILLUSTRATED EMBODIMENTS

There are several known methods of quantifying diversity in a collection, such as a collection of individuals in a video. One of the most common measurements of diversity is the Herfindahl-Hirschman Index (HHI). The HHI typically has a value ranging from 1 to ⅟N, where N is the number of different demographic categories being analyzed in a collection. For example, in calculating the racial diversity of individuals in a video across five different racial groups (N=5), a video entirely composed of individuals of just one of the racial groups, such as Asian, would have an HHI of 1, while a video that is made up equally of people from all five racial groups (most diverse), would have an HHI of 0.2. The HHI is calculated using the following formula:

$$H = {\sum }_{i = 1}^{N} {s}_{i}^{2}$$

where N is the number of different categories in a demographic being analyzed and sᵢ is the ratio of individuals that belong to a given one of those categories (i).

The most obvious shortcoming of the HHI is that the index is unable to effectively convey the difference between two collections having the same HHI, but different demographic distributions. For example, a video containing only Asian individuals would have the same HHI as a video containing only black individuals (HHI = 1). In addition, the range of HHI values (1 to ⅟N) can be confusing to understand and to visualize.

The system of the present invention utilizes an improved scoring of both diversity and disparity in videos. Compared to prior art indexes, such as the HHI, the improved scoring can be more easily understood and visualized in a software user interface, and the combination of both diversity and disparity scoring can provide a more complete picture of demographic distribution.

The system’s improved diversity scoring is generally calculated in a manner similar to the HHI, but the values are normalized to a range of 0 to 100 (or, alternatively, 0 to 1 or 0% to 100%), such that 0 means not diverse and 100 is most diverse, for example:

$$d i v e r s i t y = \left(1 - \frac{H H 1 - \frac{1}{N}}{1 - \frac{1}{N}}\right) ∗ 100$$

Again, where N is the number of different categories in a demographic being analyzed.

This normalized diversity scoring can be applied to each demographic of interest in a video or collection of videos, for example, age, gender and race, such that a video or collection of videos can have a separate age diversity score, gender diversity score and race diversity score. In addition, the scoring of different demographics can be weighted averaged to calculate an overall or cumulative diversity score for a video or collection of videos. It should be understood that the diversity scoring can be performed on any demographic of interest, such as relationship status, nationality, education, profession, and as to any parameter such as product type, topic, language, and country, and that any suitable method of calculating an overall or cumulative diversity score can be performed.

The system’s disparity scoring quantifies the difference between the types of individuals featured in a first video or collection of videos and the types of individuals featured in another video or collection of videos. The disparity scoring can be used, for example, to quantify the “uniqueness” of individuals featured in a product video found on YouTube (first video) compared to individuals found in all other videos on YouTube featuring the same product or category of product (collection of videos). The disparity scoring is generally performed using the following formula:

$$D i s p a r i t y = \left({\sum }_{i = 1}^{N} ( 1 - {c}_{i} ) ∗ {s}_{i}\right) ∗ 100$$

where cᵢ represents the number of people per category in a whole collection (e.g. all videos in a product category), sᵢ represents the number of people per category in an individual video (e.g. first video) and N is the number of demographic categories being considered.

The disparity scoring allows certain demographic categories to be weighed more heavily than others, such that greater weight can be given to demographic categories that are more “unique” or that occur less regularly in the videos. For example, if we consider only three categories in the race demographic, white, black and Asian, and if the distribution of race within those categories is 80% white, 15% black and 5% Asian among a collection of videos, the disparity scoring of a single video could place more emphasis on the number of Asian individuals featured in the video than on the number of white individuals featured in the video, thus resulting in a higher disparity score for videos featuring “unique” or less commonly occurring types of individuals.

Therefore, disparity scoring involves a summation of (1 - cᵢ) * sᵢ where cᵢ is the percentage of people in a category of a first video or collection of videos and sᵢ is the percentage of people in the same category in a second video or collection of videos. It should be understood that any suitable alternative method of weighting demographic categories can be applied to the disparity scoring.

The disparity scoring can be performed for any demographic of interest in a video or collection of videos, and the scoring of different demographics can be weighted averaged to calculate an overall or cumulative disparity score for comparing a video or collection of videos to another video or collection of videos.

The diversity and disparity scoring allow for many different types of comparisons to be made. Diversity scoring, for example, can be performed on a single video featuring a single product (e.g., Conair Ceramic Hair Dryer), on all the videos on YouTube featuring a single product, on all the videos on YouTube featuring products in the same category (e.g., all Hair Dryers) or on all videos from a single content creator (e.g., YouTube personality or influencer). Disparity scoring can be performed on videos or collections of videos to compare, for example, a single video featuring a product against all videos on YouTube featuring that product, a single video featuring a product against all videos on YouTube featuring products in the same category, or a single video featuring a product against all videos from a single content creator.

In one implementation of the system, Company X plans to target customers from demographic groups A and B for a marketing campaign. The goal of the company is to generate 50,000 click throughs from videos related to a selected product assuming an average conversion rate of 5% from the click throughs and an average order size of $40. That would generate revenue of $100,000 ($40 × 0.05 × 50,000). It is assumed that each video generates 5,000 click throughs, thus requiring 10 videos featuring the product directed at the target demographic. After analyzing 10,000 videos featuring the selected product, the system determines that only 4 videos include content featuring the targeted demographic. The system can then recommend content creators and the type of content to produce the 6 additional videos that are needed to meet the company’s revenue goal. The system can automatically or manually launch a campaign by contacting the identified content creators to produce the required videos. Content creators may be fans, social media influencers or shoppers who have purchased the product.

In another implementation of the system, when a customer having a known profile, e.g., membership in a defined demographic of a population, searches for a product or a product feature, the system can recommend videos culled from a collection of videos for viewing by the customer based on the demographic and diversity content of each of the videos in the collection. The video recommendations might be across a product category, across one brand or multiple categories and products across multiple brands. In addition to video demographics and disparity scoring, the system can analyze other dimensions such as sentiment, topics, scenes, type of creator, and a video’s visual quality. These are merely examples of the types of diversity and disparity scoring that can be performed and the types of comparisons that can be made. Further examples will now be explored with respect to certain embodiments of the system of the invention.

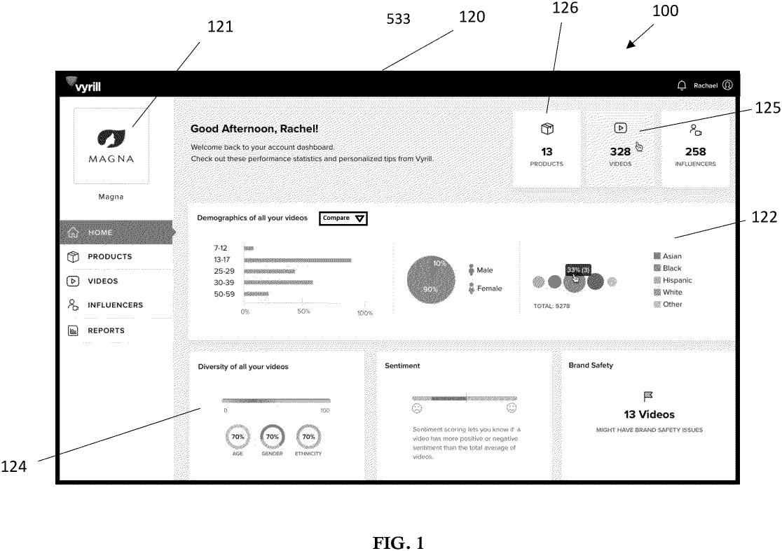

Referring to FIG. 1, the system of the invention is provided as a software application, such as a web application, software as a service (SaaS), mobile application or the like, having a user interface or dashboard (100). The dashboard (100) allows a user to see diversity and disparity scores, as well as insights gleaned from the scores, and to take actions based on those scores and insights.

The system of the invention is configured to allow a user to analyze one or more videos, for example, a user can monitor and analyze all of the videos on YouTube that feature one or more products from a single company. The exemplary dashboard (100) of FIG. 1, provides a view (120) for a brand manager (121) to see the demographic (122) and diversity information (124) for all of the videos (125) featuring products (126) that they are monitoring. Demographic information (122) can be detected in the videos using any known computer vision or machine learning algorithms or can be manually extracted from the videos. The view (120) displays diversity scores (124) for age, gender and ethnicity across all of the videos being monitored by the brand manager.

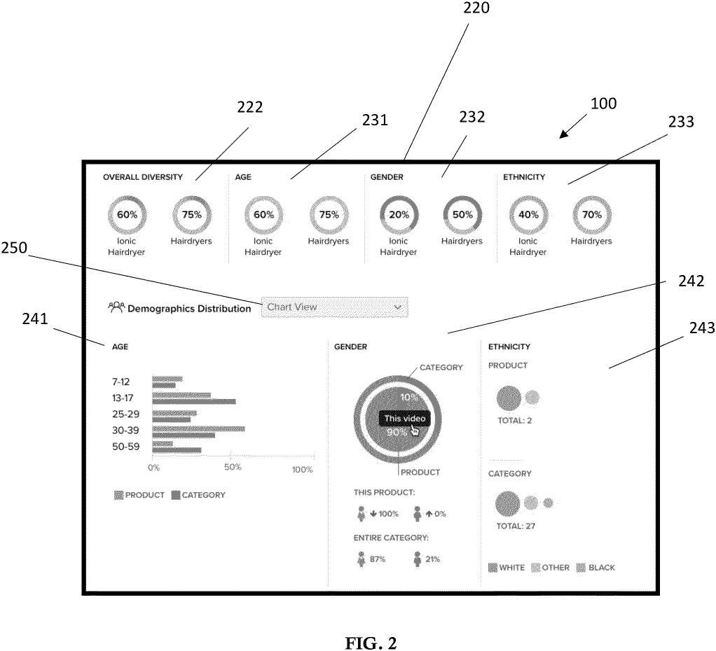

FIG. 2 shows another view (220) of dashboard (100) that enables a brand manager to compare videos she is monitoring of a single product (in this example, an ionic hairdryer being sold under her brand) against a collection of videos featuring products of the same category (in this example, all hairdryer videos on YouTube featuring her brand and the brand of her competitor’s). The view (200) shows comparisons of cumulative or overall diversity scoring (222) of individuals in the videos, diversity scores for age (231), gender (232) and ethnicity (233) in the videos, and the distributions of age (241), gender (242) and ethnicity (243) amongst individuals in the videos. The information is displayed using various bar graphs, pie charts and shapes, and a dropdown menu (250) allows the brand manager to change what styles of charts are used to display the information.

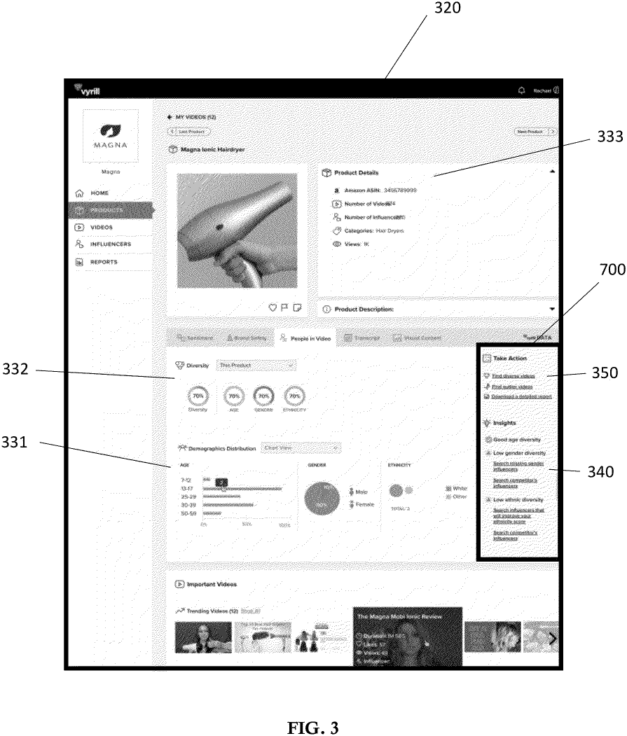

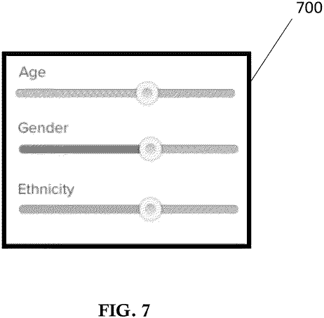

FIG. 3 shows another view (320) of dashboard (100) that enables a brand manager to see detailed demographic and diversity information for a single product (in this example, all videos on YouTube featuring the Magna Ionic Hairdryer). As described in more detail with reference to FIG. 7, the view (320) also includes a user interface component (700) that enables a brand manager to take certain actions (350) based on the demographic (331), diversity scoring (332) and product information (333) that are displayed for the product and to view high-level insights (340) gleaned from the information.

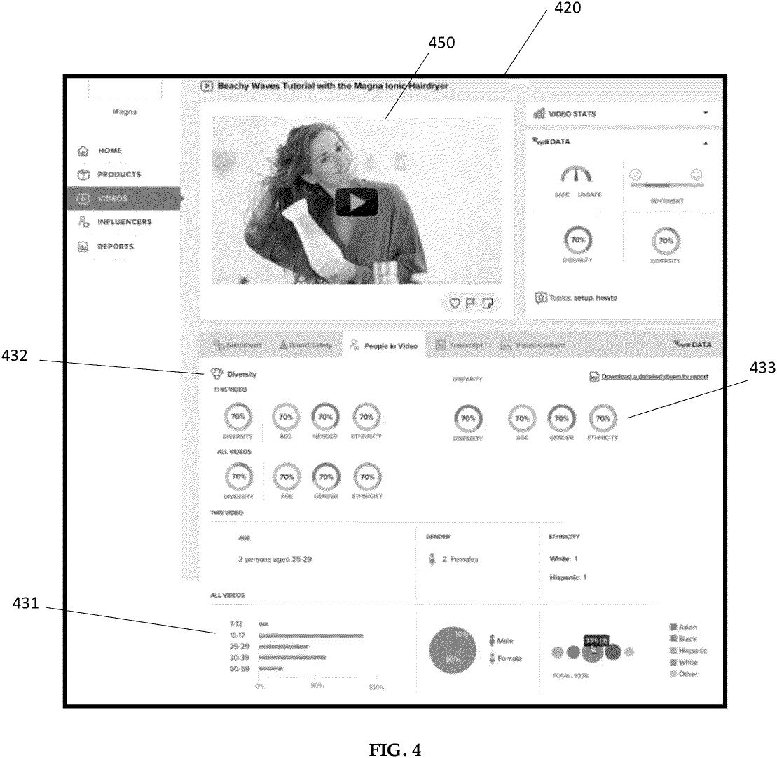

FIG. 4 shows another view (420) of dashboard (100) that enables a brand manager to see detailed demographic information (431), diversity scoring information (432) and disparity scoring information (433) for a single video (450) of a product, including comparisons of that information against that of all videos featuring the same product.

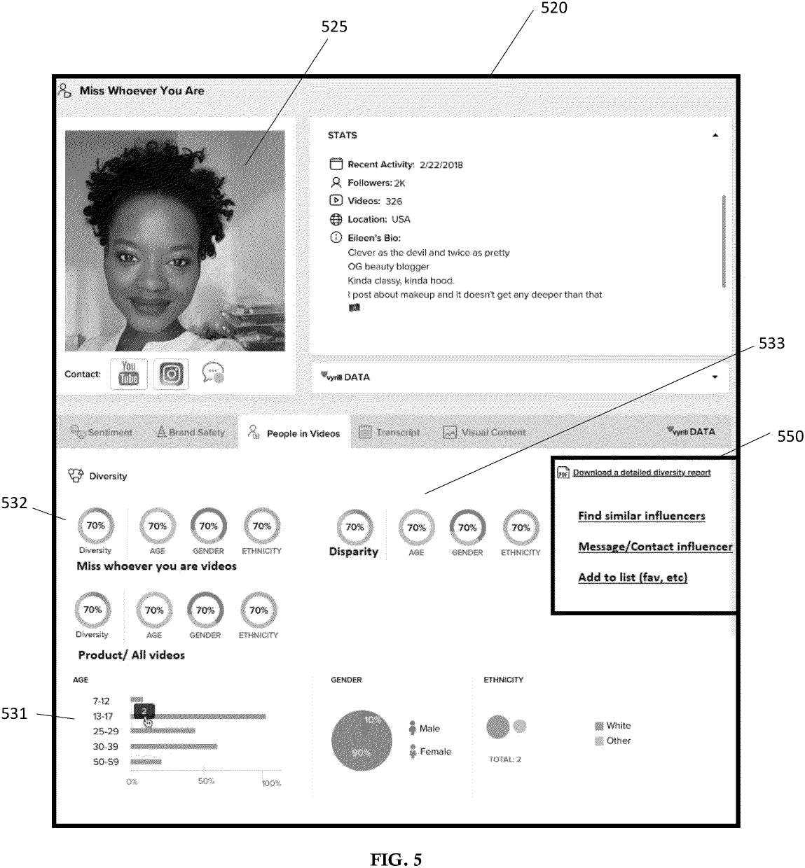

The system of the invention is configured to include a database of profiles for various content creators or influencers (i.e., users that upload content to one or more social media or content hosting platforms). Each content creator profile contains information about videos uploaded to one or more social media or content hosting platforms by that content creator. FIG. 5 shows another view (520) of dashboard (100) that enables a brand manager to see information retrieved from the profile for a single content creator (525), including demographic information (531), diversity scoring information (532) and disparity scoring information (533) for videos uploaded by that content creator, and comparisons of that information against other collections of videos. The view (520) also includes a user interface component (550) that enables the brand manager to take action based on information included in the content creator profile, including, for example, searching for profiles for similar content creators, messaging the content creator and adding the content creator profile to a favorites list.

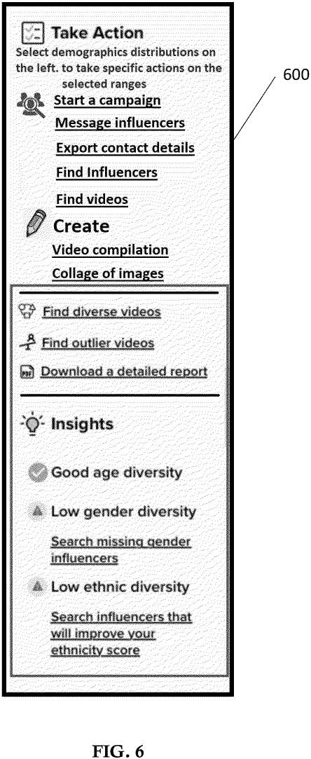

FIG. 6 shows in further detail a user interface component (600) of dashboard (100). The component (600) enables a user, such as a brand manager, to take certain actions based on the demographic information, diversity scoring information and disparity scoring information made available to them by the system and to view high-level insights gleaned from the information. In the example of FIG. 6, the user can start a promotional campaign, message content creators, export contact information for a content creator, find profiles of content creators, find videos indexed by the system, create video compilations based on videos indexed by the system, create collages of images take from videos indexed by the system, search for SEO (“search engine optimization”) terms based on demographics or download detailed reports. It should be understood that many other user actions can be enabled by the system based on the demographic information, diversity scoring information and disparity scoring information made available to the user by the system. In the example of FIG. 6, component (600) displays insight gleaned from diversity information for a collection of videos, including a general assessment of the diversity of individuals in the collection of videos and indications that the videos have low gender and ethnicity diversity scores. It should be understood that many other high-level insights can be displayed by the system based on the demographic information, diversity scoring information and disparity scoring information made available to the user by the system.

FIG. 7 shows a user interface component (700) of dashboard (100) that enables the user to adjust the relative weights assigned to age, gender and ethnicity when the system scores the overall cumulative diversity of a video or collection of videos. It should be understood that the system can be configured to generate overall or cumulative diversity scores based on a weighted averaging of various other demographic categories and that the system can enable a user to adjust the weighting based on any of those other demographic categories.

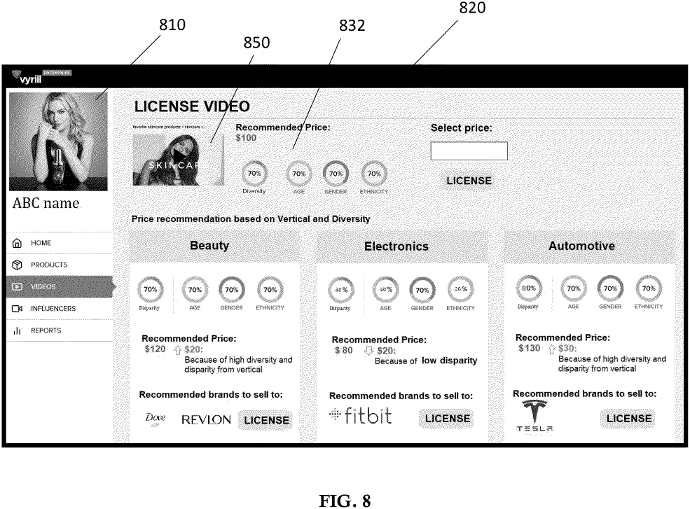

FIG. 8 shows another view (820) of dashboard (100) that enables a content creator (810) to see diversity information (832) for one of their videos (850) and to license that video to one or more brand managers representing various brands within various product categories or verticals. In the example of FIG. 8, the content creator can see recommended verticals and brands to whom they may license their video (850). These recommendations are generated based on the demographic information, diversity scoring information and demographic scoring information the system has generated or stored for videos of the various brands.

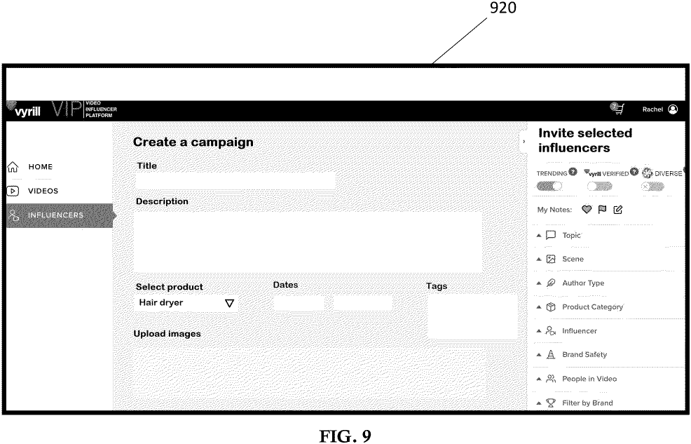

The system of the invention is configured to enable a user to create a promotional campaign based on the demographic information, diversity scoring information or disparity scoring information detected, generated and/or made available by the system. For example, in another view (920) of dashboard (100) as shown in FIG. 9, brand managers can create brand management campaigns to invite content creators to create and upload new UGVs based on their company’s products and brands and can target those brand management campaigns towards content creators with profiles that have desirable demographic, diversity scoring or disparity scoring information.

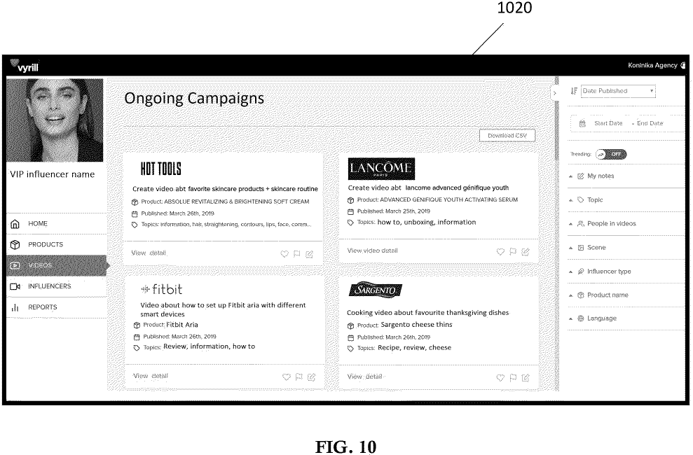

FIG. 10 shows another view (1020) of dashboard (100) that enables a content creator to connect to the ongoing brand management campaigns created and managed by brand managers using the system of the invention. In the example of FIG. 10, the content creator can search, sort and connect to various brand management campaigns created and managed by various brands.

It should be understood that the system of the invention can be configured to incorporate improvements or alternatives to the diversity and disparity scoring described herein, and that the system of the invention can be configured to analyze diversity and disparity in UGC other than recorded videos, including text, images, audio, video games, virtual reality or augmented reality applications, and live audio or video streams.

There have thus been described and illustrated certain embodiments of a system for detecting and visualizing demographics, diversity and disparity in UGVs according to the invention. These embodiments are merely example implementations of the invention and are not intended to limit the scope of the invention to their particular details. Alternative embodiments of the invention not expressly disclosed herein will be evident to persons of ordinary skill in the art.

I/ We claim:

1. A system for detecting and visualizing demographics, diversity and disparity in user-generated videos, the system comprising:
one or more collections of user-generated content relating to a defined product or service, the content having information regarding one or more defined parameters, the content in each collection accessible via a computer network for viewing on a graphical user interface,
a target collection of content for viewing on a graphical user interface, the target collection including defined diversity information regarding said one or more defined parameters,
creator content associated with one or more content creators, the creator content accessible via a computer network for viewing on a graphical user interface, the creator content containing diversity information regarding said one or more defined parameters,
a processor capable of
performing a diversity analysis of the diversity of the information associated with the user-generated content of each of said one or more collections,
comparing the diversity of information associated with a selected one of the one or more collections of the user-generated content with the diversity information associated with the target collection of content and identifying areas of disparity,
displaying an indication on a graphical user interface of the areas of disparity, and
sending an invitation to one or more content creators having creator content including diversity information associated with the identified areas of disparity to contribute content to the selected one or the one or more collections of user-generated content to reduce the disparity.

2. The system of claim 1 wherein the user-generated content includes videos.

3. The system of claim 1 wherein the information of the one or more collections of user-generated content includes demographic information.

4. The system of claim 1 further comprising:
displaying the one or more collections of user-generated content on a graphical user interface.

5. The system of claim 1 wherein the analysis of demographic information includes a diversity measurement quantifying the presence of each of said one or more defined parameters in the one or more collections.

6. The system of claim 1 wherein the diversity measurement is calculated using the formula
$$d i v e r s i t y = \left(1 - \frac{H H I - \frac{1}{N}}{1 - \frac{1}{N}}\right) ∗ 100$$
where N is the number of different parameters in a collection being analyzed.

7. A system for detecting and visualizing demographics, diversity and disparity in user-generated videos, the system comprising:
one or more collections of items of user-generated content relating to a defined product or service, the content having information regarding one or more defined parameters, the content in each collection accessible via a computer network for viewing on a graphical user interface,
a customer profile including information indicating if customer meets one of the one or more defined parameters,
a processor capable of
performing a diversity analysis of the diversity of the information associated with the user-generated content of each of said one or more collections,
selecting one or more items of user-generated content from the one or more collections, said one or more items each meeting at least one of the one or more defined parameters in the customer profile, and
causing links to each of the selected one or more items to be displayed on a graphical user interface as a group for providing easy access to the linked content by the customer.

8. The system of claim 7 wherein the user-generated content includes videos.

9. The system of claim 7 wherein the defined parameters comprise demographic information.

10. A process for detecting and visualizing demographic, diversity and disparity information in user-generated videos, the process comprising
analyzing information associated with one or more collections of user-generated content to determine the diversity of one or more defined parameters, the content relating to a defined product or service and accessible via a computer network for viewing on a graphical user interface,
identifying areas of disparity between the diversity of information associated with a selected one of the one or more collections of the user-generated content and diversity information associated with a target collection of content,
displaying an indication of the areas of disparity on a graphical user interface, and
sending an invitation to one or more content creators having creator content including diversity information associated with the identified areas of disparity to contribute content to the selected one or the one or more collections of user-generated content to reduce the disparity.

11. A process for detecting and visualizing demographic, diversity and disparity information in user-generated videos, the process comprising:
analyzing information associated with one or more collections of user-generated content to determine the diversity of one or more defined parameters, the content relating to a defined product or service and accessible via a computer network for viewing on a graphical user interface,
selecting one or more items of said user-generated content meeting at least one of the one or more defined parameters in the customer profile, and
displaying links to each of the selected one or more items on a graphical user interface as a group for providing easy access to the linked content by a customer.
